(19) United States
(12) Patent Application Publication
(10) Pub. No.: US 2008/0227478 A1
(43) Pub. Date: Sep. 18, 2008

(54) MULTIPLE FREQUENCY TRANSMITTER, RECEIVER, AND SYSTEMS THEREOF

(76) Inventors: Charles E. Greene, Cabot, PA (US); Daniel W. Harrist, Carnegie, PA (US); Michael Thomas McElhinny, Pitcairn, PA (US); Donald Corey Martin, Pittsburgh, PA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/048,529

(22) Filed: Mar. 14, 2008

Related U.S. Application Data
(60) Provisional application No. 60/918,438, filed on Mar. 15, 2007.

(51) Int. Cl. H04B 7/00

(52) U.S. Cl. 455/522

(57) ABSTRACT

A method and a system include a converter configured to convert received radio frequency signals to a direct current (DC) signal to provide power to at least a portion of a receiver. A received radio frequency signal can be associated with a plurality of carrier frequencies within a specified frequency band and time period. The received radio signals can have a total power level above a threshold power level. In some embodiments, the total power level can be above a threshold power level and below a pre-determined power level. Multiple converters can be used. Each converter can correspond to a subset of the carrier frequencies and/or to the carrier frequencies of different specified frequency bands. A combiner can combine the DC output from the converters into a single DC signal. The receiver can communicate data via a data carrier frequency associated with the carrier frequencies used for wireless power transfer.

### CROSS-REFERENCE TO RELATED APPLICATIONS

This application claims priority to and claims the benefit from U.S. Provisional Patent Application Ser. No. 60/918,438, entitled “Multiple Frequency Transmitter, Receiver, and Systems Thereof,” file on Mar. 15, 2007. The above-identified U.S. patent application is hereby incorporated herein by reference in its entirety.

This application is related to U.S. Pat. No. 7,027,311, entitled “Method And Apparatus For A Wireless Power Supply,” filed Oct. 15, 2004; U.S. patent application Ser. No. 11/356,892, entitled “Method, Apparatus And System For Power Transmission,” filed Feb. 16, 2006; U.S. patent application Ser. No. 11/438,508, entitled “Power Transmission Network,” filed May 22, 2006; U.S. patent application Ser. No. 11/447,412, entitled “Powering Devices Using RF Energy Harvesting,” filed Jun. 6, 2006; U.S. patent application Ser. No. 11/481,499, entitled “Power Transmission System,” filed Jul. 6, 2006; U.S. patent application Ser. No. 11/584,983, entitled “Method And Apparatus For High Efficiency Rectification For Various Loads,” filed Oct. 23, 2006; U.S. patent application Ser. No. 11/601,142, entitled “Radio-Frequency (RF) Power Portal,” filed Nov. 17, 2006; U.S. patent application Ser. No. 11/651,818, entitled “Pulse Transmission Method,” filed Jan. 10, 2007; U.S. patent application Ser. No. 11/699,148, entitled “Power Transmission Network And Method,” filed Jan. 29, 2007; U.S. patent application Ser. No. 11/705,303, entitled “Implementation Of An RF Power Transmitter And Network,” filed Feb. 12, 2007; U.S. patent application Ser. No. 11/494,108, entitled “Method And Apparatus For Implementation Of A Wireless Power Supply,” filed Jul. 27, 2009; U.S. patent application Ser. No. 11/811,081, entitled “Wireless Power Transmission,” filed Jun. 8, 2007; U.S. patent application Ser. No. 11/881,203, entitled “RF Power Transmission Network And Method,” filed Jul. 26, 2007; U.S. patent application Ser. No. 11/897,346, entitled “Hybrid Power Harvesting And Method,” filed Aug. 30, 2007; U.S. patent application Ser. No. 11/897,345, entitled “RF Powered Specialty Lighting, Motion, Sound,” filed Aug. 30, 2007; U.S. patent application Ser. No. 12/006,547, entitled “Wirelessly Powered Specialty Lighting, Motion, Sound,” filed Jan. 3, 2008; U.S. patent application Ser. No. 12/005,696, entitled “Powering Cell Phones and Similar Devices Using RF Energy Harvesting,” filed Dec. 28, 2007; and U.S. patent application Ser. No. 12/005,737, entitled “Implementation of a Wireless Power Transmitter and Method,” filed Dec. 28, 2007. The above-identified U.S. patent and U.S. patent applications are hereby incorporated herein by reference in their entirety.

### BACKGROUND

The disclosed systems and methods relate generally to transmitting power wirelessly and more particularly to transmitting power wirelessly where the transmitted signals include multiple carrier frequencies during a given time period.

As processor performance has increased and power requirements have decreased, there has been an ongoing explosion of devices that operate completely independent of wires or power cords. These “untethered” devices range from cell phones and wireless keyboards to building sensors and active radio-frequency identification (RFID) tags. Engineers and designers of these untethered devices continue to have to address the limitations of portable power sources, primarily batteries, as key parameters in device design. While the performance of processors and portable devices have been doubling every 18-24 months, battery technology, and particularly battery storage capacity, has only been growing at a meager 6% per year. Even with power-conscious designs and the latest available battery technology, many devices do not meet the lifetime costs and maintenance requirements for applications that involve a large number of untethered devices such as logistics and building automation. Today's devices that are configured to provide two-way communication, generally have scheduled maintenance every three to 18 months to replace or recharge the device's power source (typically a battery). Devices configured for one-way communication (e.g., broadcasting a current reading or status), such as automated utility meter readers, generally have a longer battery life, typically requiring replacement within 10 years. For both types of devices, the down time associated with scheduled power-source maintenance can be costly and disruptive to the system that a device is intended to monitor and/or control. Unscheduled maintenance down time can be even more costly and more disruptive. From a system perspective, the relatively high cost associated with having internal batteries in each untethered device can also reduce the number of devices that can be deployed in a particular system.

One approach to address the issues raised by the use of internal batteries in untethered devices can be for untethered devices or the system employing them to collect and harness sufficient energy from the external environment. The harnessed energy would then either directly power an untethered device or augment a battery or other storage component. Directly powering an untethered device enables the device to be constructed without the need for a battery. Augmenting a storage component could increase the time of operation of the device without being recharged and/or provide more power to the device to increase its functionality. Other preferred benefits include the harnessing device being able to be used in a wide range of environments, including harsh and sealed environments (e.g., nuclear reactors), to be inexpensive to produce, to be safe for humans, and to have a minimal effect on the basic size, weight and other physical characteristics of the untethered device.

Current solutions for wireless power transfer to untethered devices have focused on providing wireless power using a single frequency where the bandwidth is kept small, intentionally, to avoid interfering with communication signals. Interference is caused when a relatively strong radio frequency (RF) power signal is at or near another signal used for communication or another purpose. The strong signal will most likely interfere with or overwhelm the other signal. Thus, the strong wireless power signal's bandwidth is typically kept narrow band to avoid affecting a large range of frequency spectrum. Thus, a need exists for wireless power transfer that minimizes interference with RF signals used for communication or other purposes.

### SUMMARY

In one or more embodiments, a method and a system include a converter configured to convert received radio frequency signals to a direct current (DC) signal to provide power to at least a portion of a receiver. A received radio frequency signal can be associated with multiple carrier frequencies within a specified frequency band. The carrier frequencies of the radio frequency signal can be associated with a time period. The received radio signal can have a total power level above a threshold power level. In some embodiments, the total power level can be above a threshold power level but below a pre-determined power level. The total power level can be, for example, a time-averaged power level or an instantaneous power level. Multiple converters can be used. Each converter can correspond to a subset of the carrier frequencies and/or to the carrier frequencies of different specified frequency bands. A combiner can combine the DC output from the converters into a single DC signal. The receiver can communicate data via a data carrier frequency associated with the carrier frequencies used for wireless power transfer.

### BRIEF DESCRIPTION OF THE DRAWINGS

FIGS. 1a and 1b are illustrations of an embodiment of a wireless power system including a wireless power transmitter and a wireless power receiver.

FIG. 2 is an illustration of an embodiment of a wireless power transmitter.

FIG. 3 is a graphic illustration of a time averaged frequency spectrum.

FIG. 4 is a graphic illustration of a sine wave frequency spectrum.

FIG. 5 is a graphic illustration of an instantaneous frequency spectrum.

FIG. 6 is a graphic illustration of a multiple frequency spectrum.

FIG. 7 is an illustration of another embodiment of a wireless power transmitter.

FIG. 8 is a graphic illustration of a smeared frequency spectrum.

FIGS. 9a and 9b are illustrations of embodiments of a wireless power transmitter.

FIG. 10 is a graphic illustration of a monocycle and a truncated sine wave.

FIGS. 11a-f are graphic illustrations of an equivalent power level of two transmitted signals.

FIG. 12 is a graphic illustration of power transmitted in more than one band or around an existing signal.

FIG. 13 is a graphic illustration of power being transmitted at different power levels within a band or bands for different frequencies.

FIG. 14 is a graphic illustration of discrete frequencies approximated as a pulse.

FIG. 15 is a graphic illustration of wirelessly transmitted noise.

FIGS. 16-17 are illustrations of embodiments of a wireless power receiver.

FIGS. 18-19 are illustrations of embodiments of a wireless power transmitter.

FIGS. 20-22 are illustrations of embodiments of a wireless power system.

FIG. 23a is an illustration of another embodiment of a wireless power transmitter.

FIG. 23b is a graphic illustration of a swept frequency spectrum produced by the wireless power transmitter described in FIG. 23a.

FIG. 24 is an illustration of another embodiment of a wireless power transmitter.

FIG. 25 is a flow chart illustrating a method for wireless transmission of power using multiple frequencies.

FIGS. 26-27 are flow charts illustrating methods for receiving wirelessly transmitted power using multiple frequencies.

### DETAILED DESCRIPTION

Embodiments of the method and system for wirelessly transmitting power using multiple frequencies are described in connection with the accompanying drawing figures wherein like reference characters identify like parts throughout.

Existing radio frequency (RF) power transmission systems have shown the ability to transfer power wirelessly. These systems generally use a fixed frequency or pulse the frequencies in a sequential manner. Embodiments described herein provide a transmitter, a receiver, and a system that can be implemented to effectively transfer power wirelessly when using multiple frequencies or when the frequency spectrum contains a range of frequencies.

In certain applications, a wireless power transmitter with a single frequency (or very narrow frequency band) may not be advantageous due to the large amount of power or average power at that single frequency (e.g., carrier frequency). This large amount of power can interfere with other signals such as communication signals at or near that frequency. Existing wireless power transmission systems use modulation, such as pulsing, of a single carrier frequency. This pulsing inherently produces side lobes at frequencies around the carrier frequency. The side lobes, however, have power levels of less than half of the power at the carrier frequency. Although these existing systems contain side lobes at other frequencies and can contain harmonics due to signal distortion, these existing systems are referred to as single frequency systems because the side lobes and harmonics typically have amplitudes much lower than the carrier frequency and are of secondary importance with respect to the carrier frequency. In general, side lobes are produced by modulating the carrier frequency for the carrier to carry data. Typically, side-lobe levels are desired to be low and within close proximity compared to the carrier to ensure regulatory compliance.

The methods and systems disclosed herein describe how to spread the transmitted power across multiple frequencies while keeping their power levels comparable to one another and how to spread the frequencies apart to spread the desired power across a pre-determined band of frequencies. Such systems can be described as multiple frequency systems because they use multiple frequencies to transfer power to a wireless power receiver. Such systems can be referred to as having or using multiple fundamental or carrier frequencies.

In some embodiments, the multiple frequencies are spaced relatively far apart. In one embodiment, the multiple frequencies can be sufficiently apart to be easily viewed on a standard spectrum analyzer, such as when the frequency spacing is greater than 10 kHz, for example. For example, the multiple frequencies can have power levels within ±3 dB of an adjacent frequency.

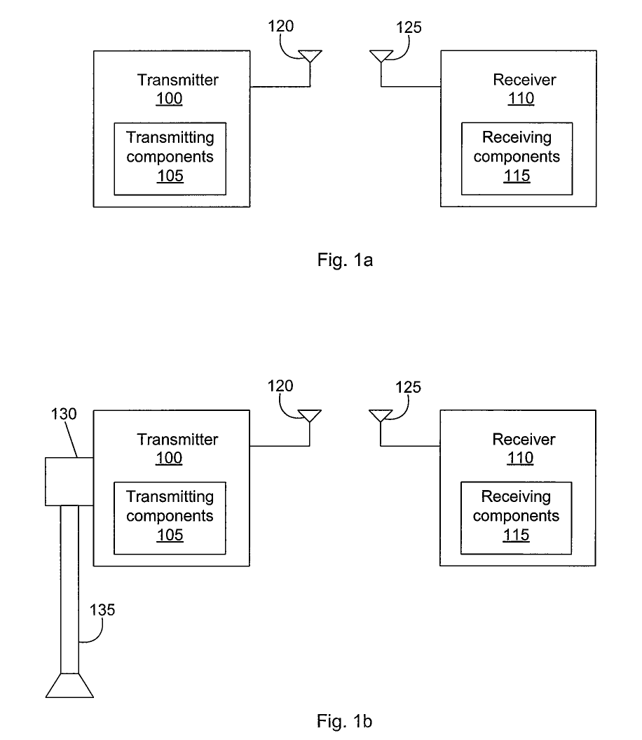

FIGS. 1a and 1b illustrate a wireless power system for providing power wirelessly to a wireless power receiver 110 via a receiving antenna 125. The system comprises a wireless power transmitter 100 that wirelessly transmits power at multiple radio frequencies via a transmitting antenna 120 to a wireless power receiver 110 that is remote from the wireless power transmitter 100. The wireless power transmitter 100 can include a support 135 for holding up or supporting the wireless power transmitter 100. The support 135 can be configured to hold the wireless power transmitter 100 to, for example, a tabletop, a wall, a floor or a ceiling. The support 135 can be coupled to the wireless power transmitter 100 through a coupler 130. In some instances, the support 135 and the coupler 130 can be integrated into a single component and/or integrated with the transmitter 100.

The wireless power transmitter 100 generates radio frequency signals for wireless power transmission via the transmitting components 105. The transmitting components 105 a n d receiving components 115 can each include modules or components that can be software-based (e.g., set of instructions executable at a processor, software code) and/or hardware-based (e.g., circuit system, processor, application-specific integrated circuit (ASIC), field programmable gate array (FPGA)). The wireless power transmitter 100 can include communications modules or components that wirelessly transmits data. In some embodiments, the wireless power transmitter 100 can transmit the multiple frequencies simultaneously.

The multiple frequencies, transmitted simultaneously, can together provide a power across a time-averaged frequency spectrum below a pre-determined power level (e.g., regulatory requirement). The wireless power transmitter 100 can transmit the multiple frequencies in pre-determined and distinct frequency bands. Alternatively, the wireless power transmitter 100 can transmit the multiple frequencies sequentially. The wireless power transmitter 100 can have the antenna 120 in electrical communication with the portion of the transmitting components 105 from which the power is wirelessly transmitted.

The wireless power transmitter 100 can be configured to transmit RF signals associated with multiple frequencies and the wireless power receiver 110 can be configured to receive RF signals associated with the multiple frequencies, for example, at the same time. In this regard, a signal associated with multiple frequencies can refer to a signal or signals that contain multiple frequency components. For example, multiple signals can refer to more than one RF carrier frequency and their associated side-lobe signals, if any.

In general, the transmitter components 105 can be configured to generate the power and the transmitting antenna 120 can be configured to radiate the wireless power to the wireless power receiver 110. The transmitter components 105 can include one or more of (not shown), and in various combinations, an oscillator, a mixer, a voltage-controlled oscillator (VCO), a phase-locked loop (PLL), a pre-amplifier, an amplifier, a directional coupler, a power detector, etc. The transmitting antenna 120 can be any antenna such as a dipole, a patch, a loop, etc.

The receiving antenna 125 can receive the wireless power from the transmitting antenna 120 and the receiver components 115 can be configured to convert the wireless power to a usable form of power, for example, direct current (DC) power. The usable form of power is delivered to core components of a device to be powered. In one embodiment, the usable form of power can be delivered to a power storage component or device for storing at least a portion of the energy associated with the received signals. The receiver components 115 can include one or more of (not shown), and in various combinations, a power harvester, an RF-to-DC converter, an alternating current (AC)-to-DC converter, a DC-to-DC converter, a diode, a metal-oxide-semiconductor field-effect-transistor (MOSFET), a rectifier, a voltage doubler, etc.

The wireless power receiver 110 can be configured to capture signals within or across an entire frequency range transmitted by the wireless power transmitter 100, for example, a range from 903-927 megahertz (MHz). In some instances, the frequency ranges can be associated with pre-determined frequency bands that have been specified by a regulatory entity for commercial, industrial, medical, and/or consumer operations, for example. For larger frequency ranges, an RF-to-DC converter with broadband matching can be used. An impedance matching circuit or network (not shown) can be used to match the input impedance of the RF-to-DC converter to the output impedance of the receiver antenna 125 over the frequency band(s) of interest. The impedance matching network can include, for example, discrete inductors, capacitors, and/or transmission lines and/or any other like components. The wireless power receiver 110 can include a power harvester (not shown) within its receiving components 115 that can be configured to convert the received RF power to a DC power.

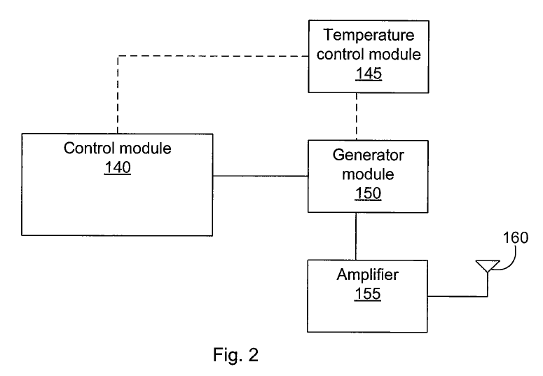

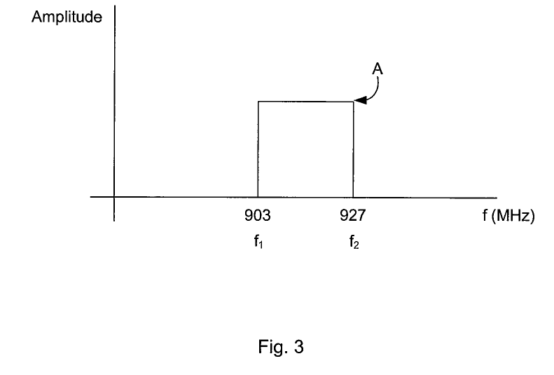

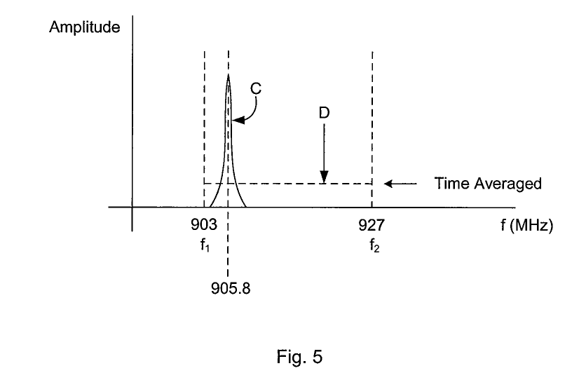

FIG. 2 shows a system block diagram of a wireless power transmitter configured to reduce or alleviate signal interference issues during wireless power transfer by changing the transmission frequency over time and across a specified range of frequencies (e.g., a frequency band specified by a regulatory entity). The wireless power transmitter can have a time-averaged frequency spectrum A as shown in FIG. 3, for example. The wireless power transmitter described in FIG. 2 can operate to lower the amplitude of the field strength (or power density) produced by the wireless power transmitter at a given frequency when averaged over time and compared to an instantaneous frequency spectrum. For example, FIG. 5 shows an instantaneous frequency spectrum by a relatively large amplitude signal C at 905.8 MHz within the frequency range 903 MHz to 927 MHz. For a time-averaged power level, the amplitude D is shown to be lower than for the instantaneous frequency spectrum.

The wireless power transmitter in FIG. 2 can be configured to transmit power (over time) using each discrete carrier frequency between a starting frequency, f₁, and an ending frequency, f₂, in a linear manner, non-linear manner, or in a random manner. Therefore, if a device, for example, a cell phone, in the vicinity of the wireless power transmitter is operating at a frequency between f₁ and f₂, the wireless power transmitter can transmit the same frequency as the device for a very small fraction of the transmitting time. As an example, a sweep from f₁ to f₂ can have a duration of less than or equal to one second. In this regard, the frequencies f₁ to f₂ used in the generation of a radio frequency signal are associated with the time period such as, for example, the sweep time. Over such a period of time, the interference between the cell phone operating frequency and the wireless power transfer frequency can be minimized. The time period can vary and can be pre-determined (e.g., 100 milliseconds, 0.5 seconds). Any interference that does occur will be very short in duration and could easily be handled by the device (e.g., cell phone) with error correction for a communication signal (which is typically already built into the communication protocol of the device), such as a Hamming code, Bose-Ray-Chaudhuri-Hocquenghem (BCH) code, Reed Solomon code, etc.

As another example, if a device is communicating with a data base station while a wireless power transmitter is sending power to a wireless power receiver, at a given instance in time the device and the wireless power transmitter can be operating on or near the same frequency. For this time period, the data base station can receive incorrect bits from the device. Due to the short duration, however, only a small number of bits will be affected and could be corrected with an error correction protocol. For an analog communication signal, the interference will be a momentary glitch, which may not even affect performance.

The wireless power transmitter shown in FIG. 2 can include a control module 140, a temperature control module 145, a generator module 150, and an amplifier module 155. In some embodiments, the wireless power transmitter can have integrated a transmission antenna 160. The generator module 150 can be configured to generate radio frequency signals associated with multiple carrier frequencies within a specified frequency band. The generator module 150 can include a voltage-controlled oscillator (VCO) (not shown). The control module 140 can be configured to control the generator module 150. For example, the control module 140 can include control mechanisms to indicate the time instance and/or the order in which the multiple frequencies are to be generated. The control module 140 can include, for example, a programmable frequency generator and/or a programmable wave generator (e.g., sinewave generator, ramp generator, triangular wave generator) (not shown).

The amplifier module 155 can be configured to control a power level of the radio frequency signals for wireless power transmission. For example, the amplifier module 155 can include a power amplifier (not shown) and can be used to control the power of the radio frequency signals. For example, the amplifier module 155 can control the power of the radio frequency signals such that they have a total time-averaged power level above a threshold power level and/or below a pre-determined power level. The amplifier module 155 can control the power of the radio frequency signals such that they have a total power that is a time-averaged power level or an instantaneous power level. The pre-determined power level can be associated with a regulatory compliance such as a maximum power level value, for example. The threshold power level can be associated with a minimum power level that may be necessary for at least a portion of a wireless power receiver to operate (e.g., monitoring operations, data communication operations, sensing operations, data processing operations, and/or power storage and control operations). The temperature control module 145 can be configured to ensure that the correct frequency is generated for an input control signal over a temperature range. In this regard, the temperature control module 145 can be configured to detect a temperature (e.g., perform a reading and/or translate the reading to an electronic value) associated with the control module 140, the generator module 150, and/or the amplifier module 155. The temperature reading can be an ambient temperature reading and can be performed at, for example, the circuit board.

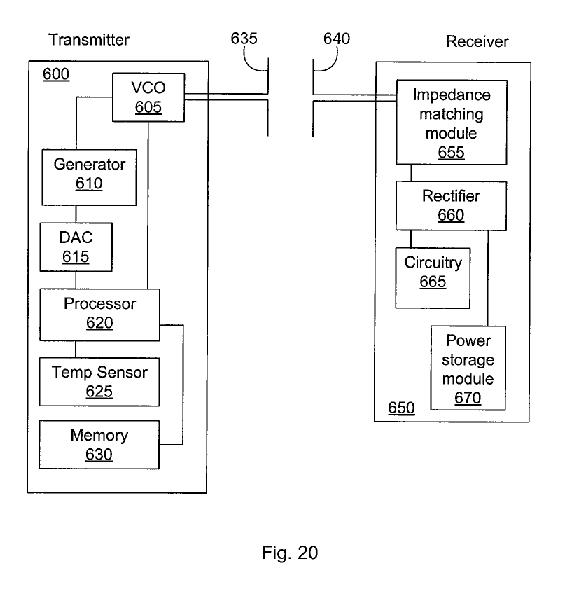

An example of an implemented wireless power transmitter includes the generator module 150 having a VCO for the 2.4-2.5 gigahertz (GHz) range. In a test embodiment of the transmitter, the VCO was a Hittite HMC385LP4. The VCO was controlled by the control module 140, which was implemented using a ramp generator. The ramp generator ramped the voltage into the VCO from 4 to 7 volts, which swept the frequency from 2.4 to 2.5 GHz. The ramp generator was designed to have a ramp up period of 10 ms and a ramp down time of 100 μs. A microcontroller, temperature sensor, and a digital-to-analog converter (DAC) were implemented for temperature compensation. The microcontroller and temperature sensor were used to measure the temperature in order to provide temperature compensation to the VCO. The microcontroller was connected to an 8-bit DAC. The DAC was used to adjust the offset of the 3 volt peak-to-peak ramp signal from a nominal value of 5.5 volts. The offset ranged from approximately 5 to 6 volts for a temperature range of −40 to +85 degrees Celsius. A dipole antenna was used due to its ability to cover the desired frequency range. The same antenna design was used for the transmitting and receiving antennas for simplicity although any type of antenna can be used. The receiver was configured to have impedance matching that provides a sufficient match between the antenna and rectifier over the entire frequency band. The complete system is shown in FIG. 20. The transmitter 600 included a VCO 605, a ramp generator 610, a DAC 615, a processor 620 (e.g., a microcontroller), and a temperature sensor 625. The transmitter 600 can also include a memory 630. The receiver 650 included an impedance matching module 655, and a rectifier 660. The receiver 650 can also include receiver operational circuitry 665 (e.g., data processing circuitry, data communication circuitry, and a power storage module 670.

This embodiment can be implemented in any band such as the 902-928 MHz band. It can be beneficial to include buffer zones at the edges of the band to ensure regulatory compliance. As an example, using a 1 MHz buffer zone at the edge of the band would result with frequencies of 903-927 MHz being transmitted during any given time period. In this example, the carrier frequency can be swept between 903 to 927 MHz over a time period in a linear, non-linear, or random manner. It should be noted that buffer zones can be used with any frequency band.

It should be noted that frequencies can be generated and transmitted in various orders. For example, a wireless power transmitter can transmit power using frequencies starting at f₁ and up to f₂ over a first time period (as was described in the example above), then using frequencies starting at f₂ and down to f₁ over a second time period that can be different than the first time period. The system can also generate frequencies for wireless power transmission starting at f₁ and up to f₂ over a first time period, and then starting at f₁ and up to f₂ over a second time period such that the transition from f₂ back to f₁ between the first time period and the second time period is instantaneous or nearly instantaneous. In some embodiments, multiple bands of frequencies can also be transmitted. As an example, the wireless power transmitter can generate and transmit frequencies between f₁ and f₂ (first frequency band) over a first time period and generate and transmit frequencies between f₃ and f₄ (second frequency band) over the first time period or over a second time period. For example, for the frequency band including frequencies between 902 MHz and 928 MHz with a 1 MHz buffer zone, a ramp generator can generate frequencies using a repeating sequence starting at 903 MHz and up to 927 MHz. For a sine or triangular wave generator, the frequency generating pattern starts at 903 MHz and up to 927 MHz and then from 927 MHz down to 903 MHz, for example.

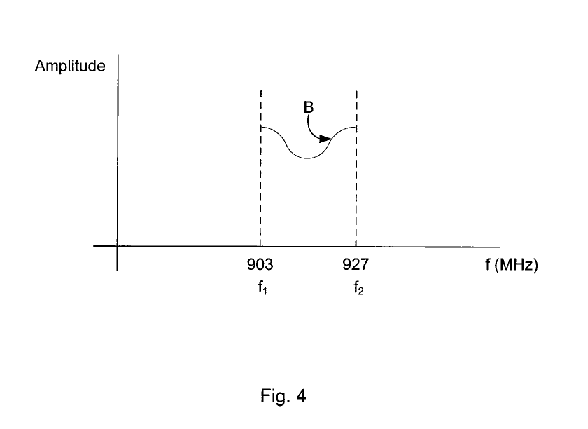

In some embodiments, the control mechanisms for frequency generation and transmission can be implemented with numerous control mechanisms, such as a waveform generator, a ramp generator, a sine wave generator, a triangle wave generator, and/or a DAC. The waveform produced by the control mechanism can affect the average power level of the frequency spectrum. As an example using a VCO, a linear ramp or triangle waveform can result in a flat average power level A over the frequency spectrum as shown in FIG. 3. A sine wave, however, will produce an average power level over the frequency spectrum with a sine shape B as shown in FIG. 4. In these embodiments, the sweep speed (period) can be substantially the same as the period of the ramp, sine, triangle wave, or other control waveform frequency. It is noted that the output power can intentionally or unintentionally change due to component changes over frequency or temperature as the frequency is swept.

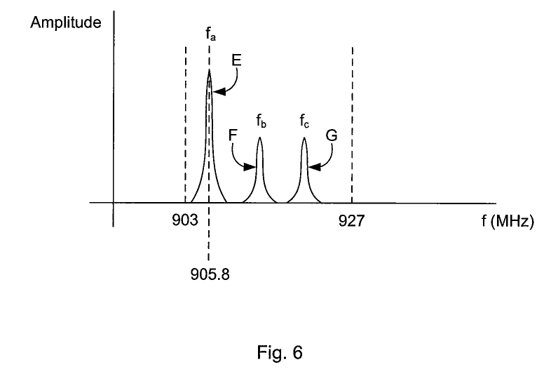

Referring to FIG. 6, in certain applications it can be beneficial to transmit multiple discrete frequencies concurrently rather than transmitting a single fixed or sweeping frequency. The resulting frequency spectrum can include multiple spikes at the multiple frequencies. The amplitude of the spikes can be less than a single spike (from a single frequency) for the same total power. As an example, if a single frequency system transmits 3 watts of power at fₐ (spike E), the spike can have an amplitude of 3 watts. Alternatively, using two frequencies, f_{b} and f_{c}, as shown in FIG. 6, the amplitude of each spike (spikes F and G respectively) would be 1.5 watts. As can be seen, adding more frequencies to the spectrum decreases the amplitude of the spikes for a given average power level and, in turn, spreads the power across a spectrum of frequencies rather than concentrating the power at a single frequency (peak power). The power level of each frequency spike can be calculated using the following equation (assumes the power is evenly distributed, which need not always be the case):

$$Power @ {f}_{x} = \frac{Total Transmitted Power}{Number of Frequencies} .$$

In this regard, the wireless power transmitter can be configured to generate RF signals associated with the multiple signals that have a total time-averaged power above a certain threshold power level to provide sufficient power transfer and/or below a certain pre-determined power level (e.g., a peak power level, regulatory level) to reduce interference.

Reducing the amplitude of the individual frequencies can reduce the risk of interference on the same or adjacent channels (e.g., carrier frequencies) by spreading the power across the spectrum. Therefore, the power on the same or adjacent channel need not overpower another signal that may be carrying communication data. As an example, a communication device can receive a data signal from its data base station while also inadvertently receiving the wireless power signal. If the power level of the wireless power signal at the frequency corresponding to the frequency of the data signal is low, the low noise amplifier used can detect or perceive both signals while still interpreting the data alone, rather than the data signal being saturated by a strong wireless power signal. The same can be true if a filter is used, for example. A strong wireless power signal may not be sufficiently attenuated by the filter and can cause interference to a data signal. Multiple lower level power signals can be easily filtered out to an amplitude that need not cause interference. As the number of frequencies used increases, the risk of interference decreases.

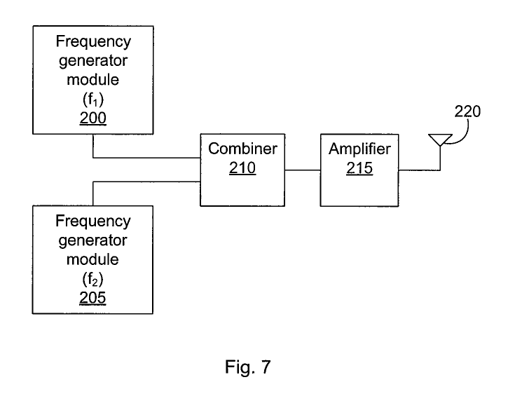

An embodiment of a wireless power transmitter is shown in FIG. 7 in which two frequency generator modules 200 and 205 can be configured to generate signals corresponding to two different frequencies f₁ and f₂, respectively. The signals generated by the frequency generator modules 200 and 205 can be combined together by a combiner 210. The combined signal, containing both frequencies, can be supplied to an amplifier 215 that can be configured to increase the power level of the combined signal (e.g., power amplifier). The output of the amplifier can be supplied to a transmission antenna 220 that can be configured to radiate the energy (e.g., RF signals) into space or a medium. The frequencies can be generated by different components and/or operations such as, for example, discrete frequency generators, VCOs, crystals, mixing frequencies, frequency modulation, and/or any other method that can generate two or more different frequencies.

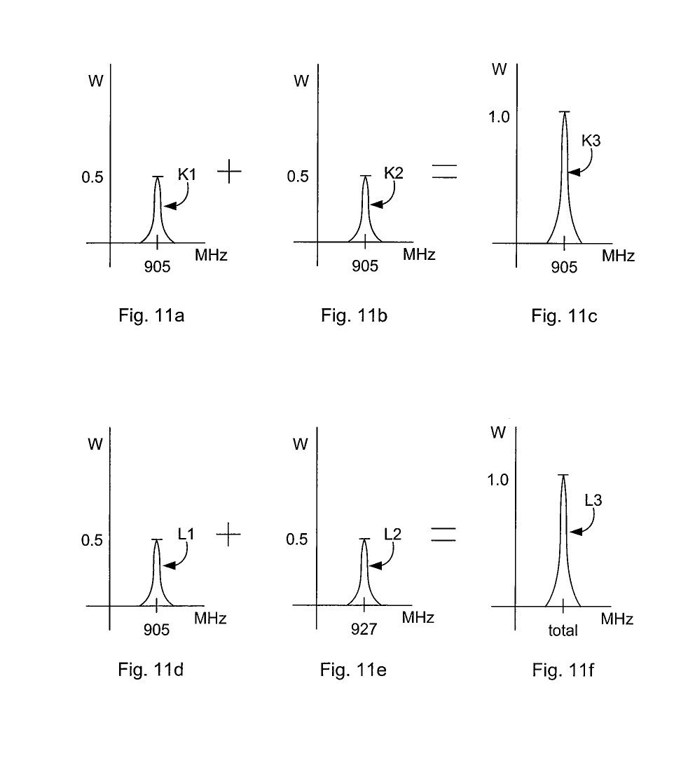

It should be noted that the receiver can combine the received power signals that are associated with the transmitted frequencies and can convert them with a conversion efficiency that corresponds to the sum of the power levels of the signals associated with the individual frequencies. As an example, it was shown that a power signal with a single frequency at 0 dBm input power converted at a 66% efficiency at the receiver, while a power signal with a single frequency at 3 dBm converted at a 70% efficiency at the receiver. It was also shown that a signal with two frequencies each at 0 dBm (corresponding to a total power of 3 dBm) also converted at an approximately 70% efficiency. Therefore, reducing the level of the individual frequencies does not degrade the performance of the receiver as long as the total power is the same, as shown in FIGS. 11a-f.

FIG. 11a shows a first wireless power signal K1 at 905 MHz received by the receiver. FIG. 11b shows a second wireless power signal K2 at 905 MHz received by the receiver. FIG. 11c shows the equivalent power level K3 at which the receiver converts the power such that it includes the power of the signal from FIG. 11a and that of the signal from FIG. 11b. The power levels associated with different signals can be assumed to add completely when the frequencies of the signals are sufficiently close.

FIG. 11d shows a first wireless power signal L1 at 905 MHz received by the receiver. FIG. 11e shows a second wireless power signal L2 at 927 MHz received by the receiver. FIG. 11f shows the equivalent power level at which the receiver converts the power such that it includes the power of the signal from FIG. 11d and that of the signal from FIG. 11e. For example, a receiver can receive the signal L1 corresponding to the 905 MHz frequency at substantially the same time (e.g., simultaneously) as another it receives the signal L2 corresponding to the 927 MHz frequency.

In certain applications, it may be beneficial to produce multiple frequencies concurrently and sweep those frequencies over time. Each resulting frequency at an instance in time would have a reduced amplitude compared to a fixed frequency system as previously described by the equation:

$$Power @ {f}_{x} = \frac{Total Transmitted Power}{Number of Frequencies} .$$

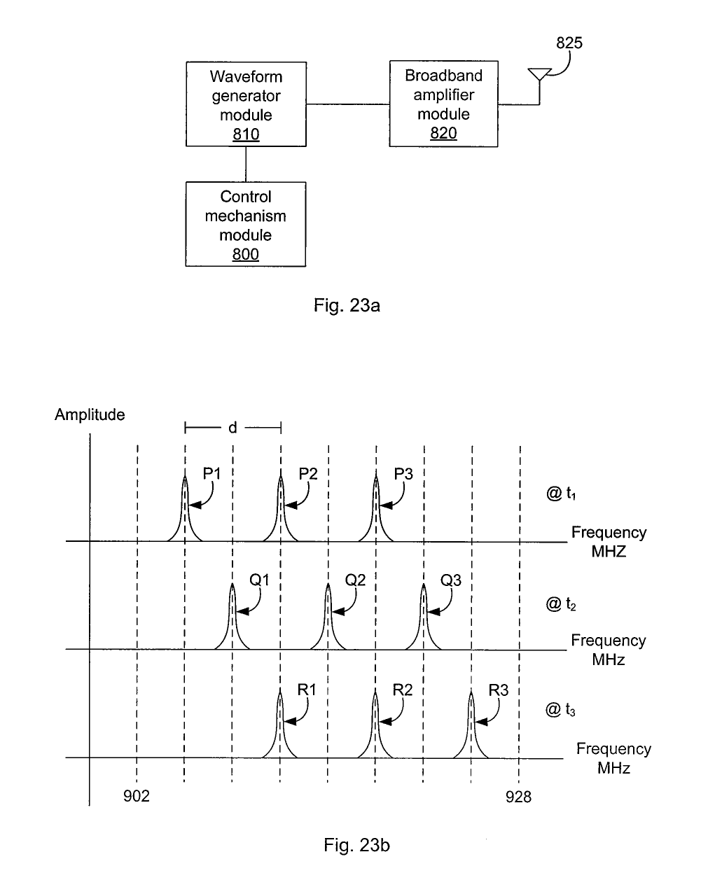

The average amplitude, however, can be even lower when examining the time average. This transmission method can further reduce the power at each frequency and help smear the power across the band or bands of interest. An example of such a transmitter and spectrum can be seen in FIGS. 23a and 23b, respectively. It should be noted that the channel spacing, d, may vary with time and/or as the frequencies are swept. It should also be noted that the amplitudes of each frequency may be different or vary with time.

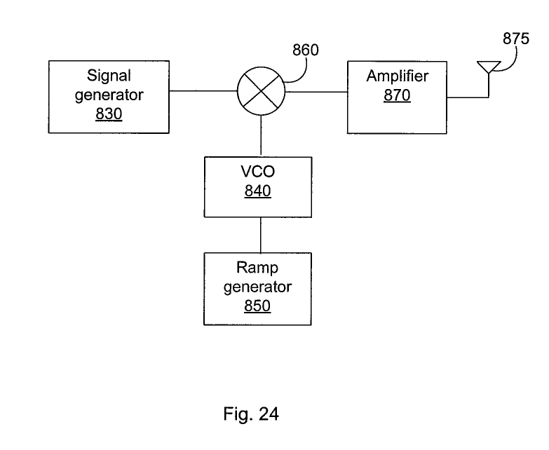

The wireless power transmitter shown in FIG. 23a can include a control mechanism module 800, a waveform generator module 810, a broadband amplifier 820, and a transmission antenna 825. As implemented, the wireless power transmitter can include a VCO 840, a signal generator 830, and a mixer 860 as the waveform generator, as shown in FIG. 24. The control mechanism in the control mechanism module 800 can be implemented using a ramp generator. The VCO frequency can be swept from 910 to 920 MHz while the signal generator 830 can generate a signal with a frequency at 1 MHz. These two signals can be mixed and supplied to an amplifier 870 that was connected to a transmission antenna 875. The ramp generator 850 can be used to sweep the VCO frequency while the signal generator 850 can be held at 1 MHz. Such a design can produce a spectrum over time similar to the one shown in FIG. 23b. The transmission spectrum in FIG. 23b illustrates sending power wirelessly by transmitting a subset or portion of the multiple frequencies at one time instance (e.g., P1, P2, and P3 are generated and transmitted at t₁) while sending different subsets or portions at different times instances (e.g., Q1, Q2, and Q3 at t₂ and R1, R2, and R3 at t₃).

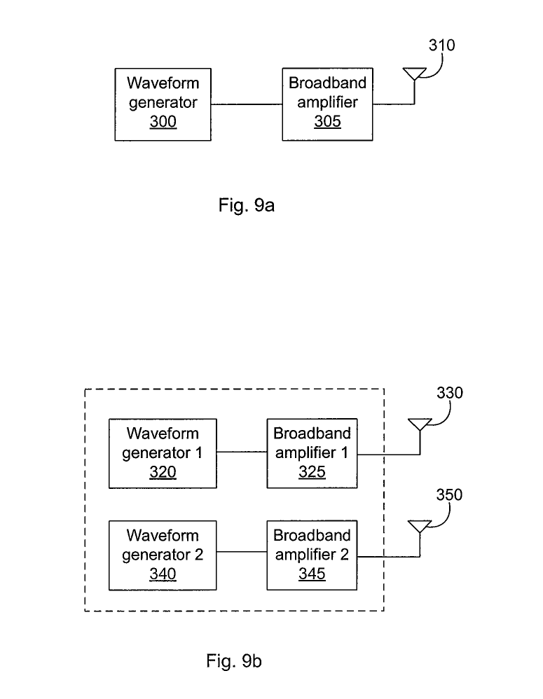

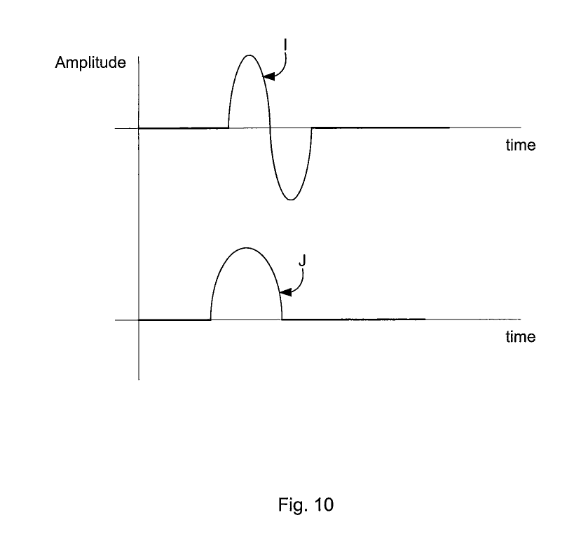

In certain applications, it may be advantageous to smear the spectrum across a band without producing discrete frequencies. In other words, the frequency spectrum can be continuous rather than having spikes like the previous embodiment. This type of frequency spectrum can be produced by using the proper waveform in the time domain. As an example, a monocycle or truncated sine wave H as shown in FIG. 10 can be used. The antennas and receiver, as with the other embodiments, can be configured to accommodate the bandwidth of the desired frequency spectrum. FIGS. 9a and 9b show how a transmitter could be configured for this type of implementation. As shown in FIG. 9a, the wireless power transmitter can include a waveform generator 300 and a broadband amplifier 305. The signals generated by the waveform generator 300 and amplified by the broadband amplifier 305 can be transmitted (e.g., broadcast) via a transmission antenna 310. In FIG. 9b, the wireless power transmitter can include a first waveform generator 320 (waveform generator 1), a second waveform generator 340 (waveform generator 2), a first broadband amplifier 325 (broadband amplifier 1), and a second broadband amplifier 345 (broadband amplifier 2). The signals generated by the waveform generators 1 and 2 and amplified by the broadband amplifiers 1 and 2 can be transmitted via transmission antennas 330 and 350 respectively.

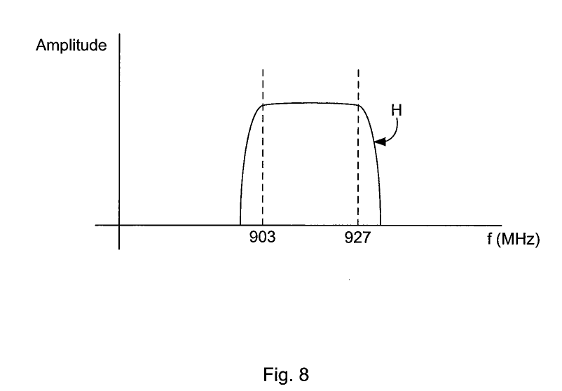

The wireless power transmitters described in FIGS. 9a and 9b can reduce or eliminate interference by smearing the transmitted power across a band of frequencies rather than having a single strong signal, as shown in FIG. 8. For example, by using an appropriate time-domain waveform, the frequency spectrum can be smeared (e.g., not time-averaged but instantaneous) as illustrated by the spectrum H in FIG. 8. As previously described, the receiver can convert at an efficiency corresponding to the total power level. It should be noted that as shown in FIG. 9b, the wireless power transmitter can have multiple waveform generators, amplifiers, and/or antennas to produce the desired transmitted spectrum. Specifically, the waveform generator 1, broadband amplifier 1, and transmission antenna 220 can be in a first frequency band, such as 902-928 MHz, for example. While the waveform generator 2, broadband amplifier 2, and transmission antenna 350 can be in a second and different frequency band, such as 2.4-2.5 GHz, for example. Another example of a frequency band can include frequencies in the range of 3 GHz to 10 GHz. For example, various embodiments operate in a spectrum of less than 500 MHz. For frequencies less than 2 GHz, however, the system can operate at less than 25% of the center frequency. As shown in FIG. 10, the waveform from a waveform generator can be monocycle (e.g., waveform J), a truncated sine wave (e.g., waveform I), or a truncated triangular wave (not shown).

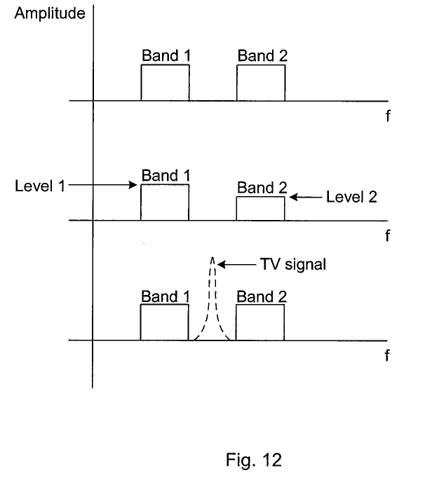

FIG. 12 illustrates how the power can be transmitted wirelessly in more than one band or around an existing signal. The field strength (or power density) in each band can have different power levels (e.g., meet different thresholds or pre-determined power levels) and/or the power level can vary in any way across frequencies (flat power level shown in FIG. 12). As an example, power can be transmitted in the 902-928 MHz industrial, scientific, and medical (ISM) band and in the 2.4-2.5 GHz ISM band. Also, power can be transmitted at the edges of a TV band around the TV signal occupying the center part of the band. In another example, power can be transmitted at the edges of a communication band around the communication signal occupying the center part of the band. In some instances, the power associated with each frequency (e.g., carrier frequency) in a received radio frequency signal can be less than 100 milliwatts (mW), for example. In this regard, a radio frequency signal that uses 10 carrier frequencies can provide 1 Watt of power, for example. The amount or level of the power received can vary according to the distance between the wireless power receiver and the wireless power transmitter. In one embodiment, the total power (e.g., time-averaged or instantaneous) of a radio frequency signal can be approximately 1 mW at 1 meter away from the wireless power transmitter. In such an embodiment, approximately 3 Watts of transmitted power associated with the radio frequency signal may be needed to assure a 1 mW of power at 1 meter away from the transmitter.

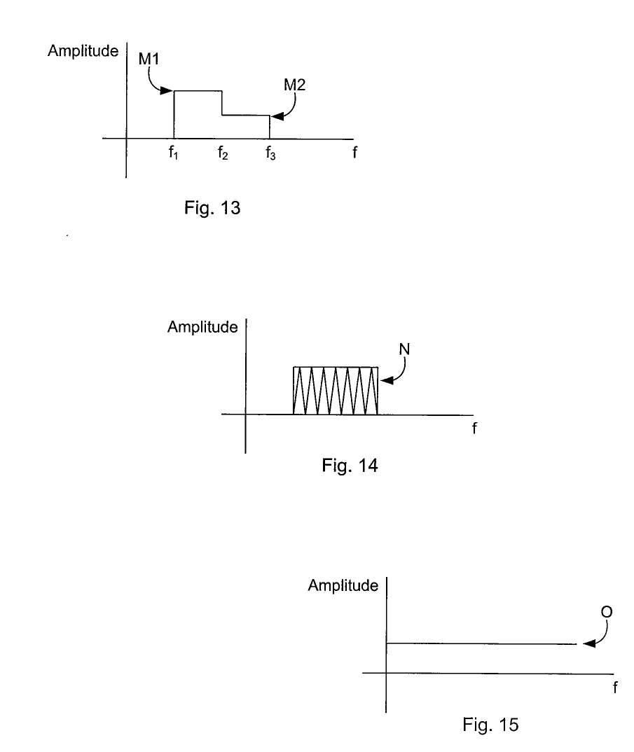

FIG. 13 illustrates how power can be transmitted at different power levels (e.g., M1 and M2) within a band or bands for different frequencies. This could be appropriate to meet regulatory requirements for specific frequency bands. FIG. 14 illustrates how the spectrum can be approximated as a pulse, but in fact be made of many discrete frequencies that appear to form a pulse due to the close spacing. FIG. 15 illustrates how, in certain applications, it can be beneficial to transmit noise across a very wide range of frequencies (e.g., white noise). By increasing the RF noise floor by a sufficiently large amount, it can be possible to supply power to a receiver. The antenna used on the transmitter and receiver could be a single wideband antenna (log-periodic antenna) or multiple antennas that cover a portion of the required spectrum.

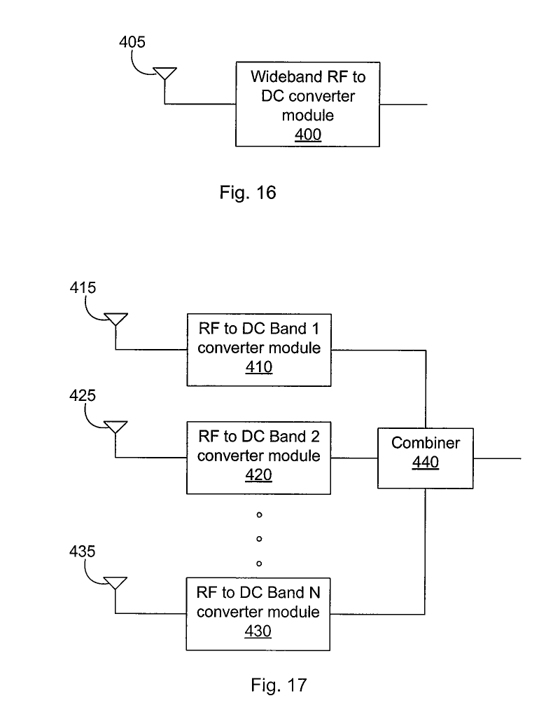

FIG. 16 shows a wireless power receiver implemented as a single wideband receiver that includes a receiver antenna 405 and a wideband RF-to-DC converter module 400. FIG. 17 illustrates a different embodiment in which the wireless power receiver can be implemented using multiple antennas and/or rectifiers where the outputs of each rectifier can be combined together. For example, the embodiment described in FIG. 17 includes receiving antennas 415, 425, and 435 with corresponding RF-to-DC band converter modules 410, 420, and 430, and combiner 440. In some instances, the combining can be done with a simple wired connection, for example.

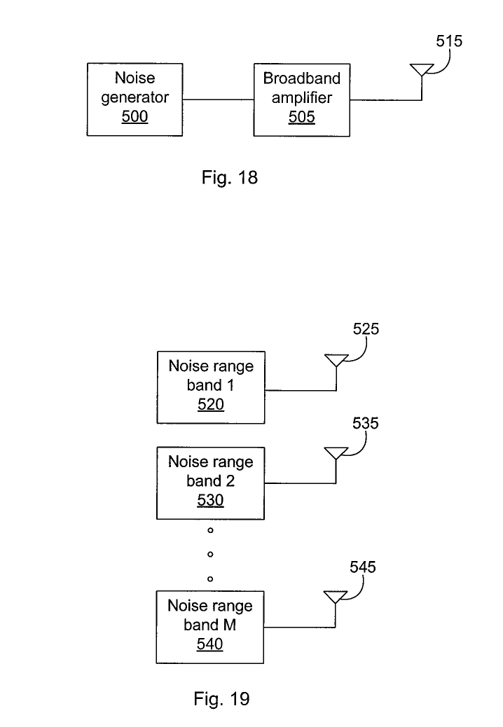

FIG. 18 shows another embodiment of a wireless power transmitter implemented using as a single noise generator 500 connected to a wideband (e.g., broadband) amplifier 505 where the amplifier drives a wideband antenna 515 which radiates the energy. FIG. 19 illustrates another embodiment of a wireless power transmitter implemented as multiple noise generators 520, 530, and 540 with multiple antennas 525, 535, and 545 where each operates in a specific frequency band. A wireless power receiver and a wireless power transmitter using a wide band antenna are shown in FIGS. 16 and 18, respectively, while a wireless power receiver and a wireless power transmitter using a multiple antenna system are shown in FIGS. 17 and 19, respectively. It should be noted that the receiver can be configured to capture or receive a portion of the frequency band transmitted (e.g., a subset of the carrier frequencies) by the RF power transmitter. This configuration can result when size and/or cost restrictions limit the receiver device. In other words, the receiver requirements can be such that it is too small to include multiple antennas or a single very broadband antenna.

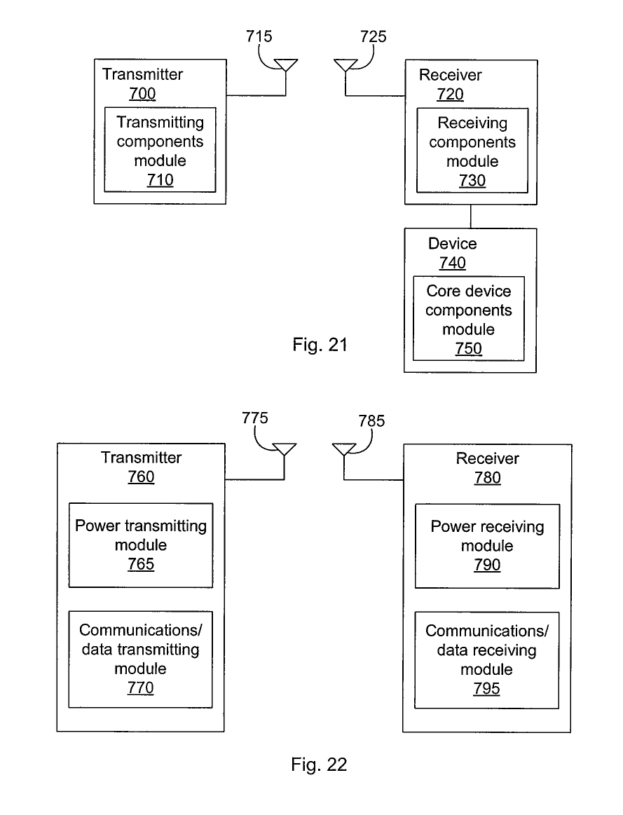

FIGS. 21 and 22 describe other embodiments of a wireless power transmitter and a wireless power receiver. For example, FIG. 21 illustrates a wireless power transmitter 700 and a wireless power receiver 720. The wireless power transmitter 700 can include a transmitting components module 710 and a transmission antenna 715. The wireless power receiver 720 can include a receiving components module 730 and a receiver antenna 725. A device 740 is shown separate but coupled to the wireless power receiver 720. The device 740 (e.g., a cell phone) can include a core device components module 750. The transmitting components module 710 and the receiving components module 730 can include one or more modules to provide the operations described herein for the transmission and reception of power wirelessly via multiple frequencies, respectively.

FIG. 22 illustrates a wireless power transmitter 760 and a wireless power receiver 780. The wireless power transmitter 760 can include a power transmitting module 765, a communications/data transmitting module 770, and a transmission antenna 775. The wireless power receiver 780 can include a power receiving module 790, a communications/data receiving module 795, and a receiver antenna 785. The power transmitting module 765 and the power receiving module 790 can include one or more modules to provide the operations described herein for the transmission and reception of power wirelessly via multiple frequencies, respectively. Moreover, the communications/data transmitting module 770 and the communications/data receiving module 795 can include one or more modules to provide the operations described herein for the transmission and reception of data wirelessly via the multiple frequencies used for wireless power transfer, respectively.

A minimum or threshold power level can be transmitted from the transmitters 700 and 720 such that a certain power level is received by the receivers 720 and 780, respectively. In some embodiments, the threshold power level can be sufficient to provide the receivers 720 and 780 with a certain power level within a specified distance from the transmitters such that the power level received can power up portions of the operation of the receivers 720 and 780. For example, the power level received can be sufficient to provide power to at least a portion of the core devices components module 750 in the device 740. Similarly, the power level received can be sufficient to provide power to at least a portion of the communications/data receiving module 795 in the receiver 780. In some embodiments, the threshold power level from the transmitters 700 and 720 can be dynamically adjusted based on, for example, information provided from the receivers 720 and 780, respectively. In some embodiments, the information provided by the receivers 720 and 780 can be feedback information from currently received power levels or can be initial information (e.g., prior to receiving wirelessly-transmitted power) indicating minimum power level requirements.

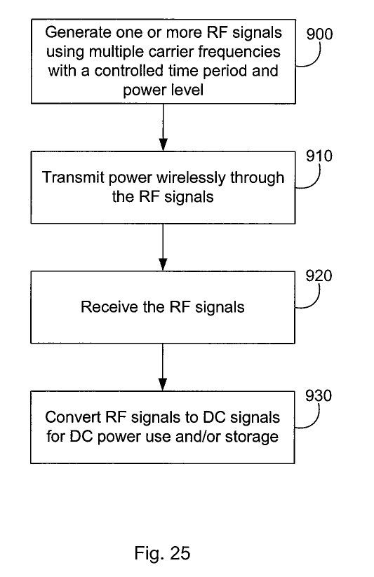

FIG. 25 is a flow chart illustrating a method for wireless transmission of power using multiple frequencies, according to an embodiment. In 900, a wireless power transmitter can generate one or more RF signals associated with multiple frequencies to wirelessly transmit at, for example, a controlled power level and/or a controlled time period associated with the multiple frequencies. In this regard, the wireless power transmitter can control, for example, the carrier frequency value, the number of carrier frequencies, the time instance at which each carrier frequency is generated, the transmission period, and/or modulation schemes. In 910, the wireless power transmitter can broadcast the RF signals. In general, a minimum threshold power level or a maximum pre-determined power level associated with an RF signal can be considered with respect to the power level at the point of transmission by a wireless power transmitter. In other instances, a minimum threshold power level or a maximum pre-determined power level associated with an RF signal can be considered with respect to the power level at the point of reception by a wireless power receiver.

In 920, a wireless power receiver can receive the RF signals. The power associated with the received RF signals can be different from the power associated with the RF signals at the point of transmission from the wireless power transmitter. In 930, the wireless power receiver can use one or more RF-to-DC converters (e.g., power harvesters) to convert the received RF signals to a DC signal. The power associated with the DC signal can be used to power (e.g., energize) at least a portion of the receiver and/or can be stored in a power storage component (e.g., battery).

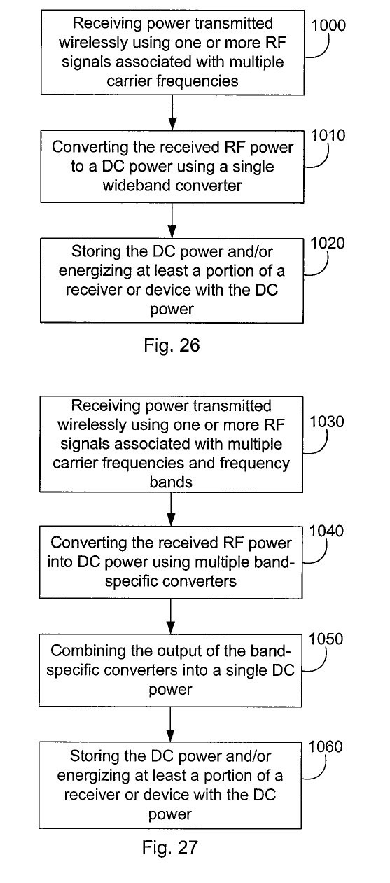

FIGS. 26-27 are flow charts illustrating methods for receiving wirelessly transmitted power using multiple frequencies, according to an embodiment. As shown in FIG. 26, in 1000, a wireless power receiver receives one or more RF signals associated with multiple frequencies from a wireless power transmitter. In 1010, the wireless power receiver can convert the received RF signals into a DC signal by using a single wideband RF-to-DC converter. In 1020, the power associated with the DC signal can be used to power, for example, at least a portion of the receiver and/or can be stored in a power storage component. In another example, the power associated with the DC signal can be used to power at least a portion of a device coupled to the receiver and/or can be stored in the device. As shown in FIG. 27, in 1030, a wireless power receiver can receive one or more RF signals associated with multiple frequencies from a wireless power transmitter. In 1040, the wireless power receiver can convert the received signals into a DC signal by using multiple RF-to-DC converters, each converter can correspond to, for example, a different subset of the multiple frequencies or to a different specified frequency band (e.g., ISM band). In 1050, the output from each of the converters can be combined to produce a single DC signal. In 1060, the power associated with the single DC signal can be used to power, for example, at least a portion of the receiver and/or can be stored in a power storage component. In another example, the power associated with the DC signal can be used to power at least a portion of a device coupled to the receiver and/or can be stored in the device.

It should be noted that the embodiments described herein not only help to reduce or eliminate interference, but also dead spots. Because, the locations of dead spots are generally determined by the wavelength of the signal, the embodiments described herein also help to eliminate dead spots. Basically, all frequencies will not have the same locations for dead spots meaning that some power can be available at the receiver from those frequencies that do not have a dead spot at the receiver location.

It should be noted that any of the embodiments described herein can be pulsed, as described in the incorporated references discussed above. It should also be noted that the wireless power can contain data or not. When the wirelessly-transmitted power contains data, one or more data carrier frequencies can be used from the multiple frequencies to communicate data between a wireless power transmitter and a wireless power receiver. In this regard, one or more of the multiple frequencies can be modulated to include data in the signal or a separate channel can be used to send only data. The signal can be interpreted by the wireless power receiver or by a separate data receiver. The signal received by the wireless power receiver of the invention can be considered to have data when the RF signals received contain data that can be interpreted and used by the receiver, preferably at the same time that the receiver is also converting the received energy into DC power.

It should be noted that the embodiments described herein can also assist in regulatory compliance. Frequencies in certain bands are regulated by the average value. The embodiments described herein not only have low average values at discrete frequencies in the band of interest, but can also have low average values of generated harmonics. Thus, these systems need not require as much design time to ensure regulatory compliance. As an example, a filter can be typically placed between the output of the amplifier and the antenna to remove unwanted frequency components such as harmonics. For at least some of the embodiments described herein, the filter not need attenuate the harmonics as much as a filter used in a single frequency wireless power transmission system. This can reduce cost and/or size of the filter.

### CONCLUSION

While various embodiments have been described above, it should be understood that they have been presented by way of example only, and not limitation. For example, the wireless power receiver or the wireless power transmitter described herein can include various combinations and/or sub-combinations of the components and/or features of the different embodiments described. It should be understood that the wireless power receiver can receive power from more than one wireless power transmitter and that the wireless power transmitter can broadcast power to more than one wireless power receiver.

Some embodiments include a processor and a related processor-readable medium having instructions or computer code thereon for performing various processor-implemented operations. Such processors can be implemented as hardware modules such as embedded microprocessors, microprocessors as part of a computer system, Application-Specific Integrated Circuits (“ASICs”), and Programmable Logic Devices (“PLDs”). Such processors can also be implemented as one or more software modules in programming languages as Java, C++, C, assembly, a hardware description language, or any other suitable programming language.

A processor according to some embodiments includes media and computer code (also can be referred to as code) specially designed and constructed for the specific purpose or purposes. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as optical disks, and read-only memory (“ROM”) and random-access memory (“RAM”) devices. Examples of computer code include, but are not limited to, micro-code or micro-instructions, machine instructions, such as produced by a compiler, and files containing higher-level instructions that are executed by a computer using an interpreter. For example, an embodiment of the invention can be implemented using Java, C++, or other object-oriented programming language and development tools. Additional examples of computer code include, but are not limited to, control signals, encrypted code, and compressed code.

What is claimed is:

1. An apparatus, comprising:
a converter module configured to receive at least one radio frequency signal, the converter module configured to convert the received radio frequency signal to a DC signal, the received radio frequency signal being associated with a plurality of carrier frequencies within a specified frequency band, the plurality of carrier frequencies being associated with a pre-determined time period.

2. The apparatus of claim 1, wherein the DC signal provides power to at least one of a receiver or a device.

3. The apparatus of claim 1, wherein the received at least one radio frequency signal has a total power level above a threshold power level.

4. The apparatus of claim 1, wherein the received at least one radio frequency signal has a total time-averaged power level above a threshold power level.

5. The apparatus of claim 1, wherein the received at least one radio frequency signal has a total instantaneous power level above a threshold power level.

6. The apparatus of claim 1, wherein the converter module is a first converter module, the apparatus further comprising a second converter module and a combiner module, the combiner module configured to combine an output from the first converter module and the second converter module into the DC signal.

7. The apparatus of claim 1, further comprising a plurality of converter modules including the converter module, each converter module from the plurality of converter modules configured to receive at least one radio frequency signal associated with a different subset of carrier frequencies from the plurality of carrier frequencies.

8. The apparatus of claim 1, further comprising a data communication module configured to receive data via a radio frequency signal associated with a data carrier frequency within the specified frequency band and associated with the plurality of carrier frequencies.

9. The apparatus of claim 1, wherein the specified frequency band is a regulatorily-specified frequency band.

10. The apparatus of claim 1, wherein the received at least one radio frequency signal has a total power level below a pre-determined power level.

11. The apparatus of claim 1, wherein the received at least one radio frequency signal has a total power level below a pre-determined power level associated with a regulatory compliance value.

12. The apparatus of claim 1, wherein the received at least one radio frequency signal has a total power level above a threshold power level associated with an operational power level for a data communication portion of a device being powered by the DC signal.

13. An apparatus, comprising:
a plurality of converter modules, each converter module from the plurality of converter modules configured to receive at least one radio frequency signal uniquely associated with a frequency band form a plurality of frequency bands, the frequency band associated with one converter module being different from the frequency band associated with each remaining converter module, each converter module from the plurality of converter modules configured to convert the received radio frequency signals to a DC signal.

14. The apparatus of claim 13, wherein the DC signals from the plurality of converter modules provide power to at least one of a receiver or a device.

15. The apparatus of claim 13, wherein one frequency band from the plurality of frequency bands and associated with one converter module from the plurality of converter modules includes carrier frequencies in the range of 902 megahertz to 928 megahertz.

16. The apparatus of claim 13, wherein one frequency band from the plurality of frequency bands and associated with one converter module from the plurality of converter modules includes carrier frequencies in the range of 902 megahertz to 928 megahertz, each carrier frequency in that frequency band being approximately 10 kilohertz apart from an adjacent carrier frequency.

17. The apparatus of claim 13, wherein one frequency band from the plurality of frequency bands and associated with one converter module from the plurality of converter modules includes carrier frequencies in the range of 2.4 gigahertz to 2.5 gigahertz.

18. The apparatus of claim 13, wherein one frequency band from the plurality of frequency bands and associated with one converter module from the plurality of converter modules includes carrier frequencies in the range of 3 gigahertz to 10 gigahertz.

19. The apparatus of claim 13, wherein the received at least one radio frequency signal associated with each frequency band from the plurality of frequency bands has a total time-averaged power level or a total instantaneous power level above a threshold power level.

20. The apparatus of claim 13, further comprising a combiner module, the combiner module configured to combine the DC signal from each converter module from the plurality of converter modules into a single DC signal.

21. An apparatus, comprising:
a generator module configured to generate at least one radio frequency signal associated with a plurality of carrier frequencies within a specified frequency band, the plurality of carrier frequencies being associated with a pre-determined time period;
a control module configured to control the generator module; and
an amplifier module configured to control a power level of each radio frequency signal for wireless power transmission.

22. The apparatus of claim 21, wherein the amplifier module is configured to control the power level of each radio frequency signal such that the radio frequency signal has a total time-averaged power level above a threshold power level.

23. The apparatus of claim 21, wherein the control module is configured to send a control signal to the generator module, the control signal configured such that the generator module generates each carrier frequency associated with the radio frequency signal having a transmission order and a transmission instance.

24. The apparatus of claim 21, further comprising a temperature control module configured to adjust the generator module based on a temperature reading at one or more of the generator module, the control module, or the amplifier module.

25. The apparatus of claim 21, wherein the generator module includes a voltage control oscillator.

26. The apparatus of claim 21, wherein the generator module is a first generator module, the apparatus further comprising a second generator module and a combiner module, each of the first generator module and the second generator module being configured to generate a different subset of carrier frequencies from the plurality of carrier frequencies, the combiner module being configured to combine the generated carrier frequencies from the first generator module and the second generator module to produce the at least one radio frequency signal.

27. The apparatus of claim 21, further comprising a support configured to hold at least one of the control module, the generator module, or the amplifier module.

28. The apparatus of claim 21, wherein the control module includes at least one of a waveform generator or a frequency generator.

29. The method of claim 21, further comprising transmitting the at least one radio frequency signal associated with the plurality of carrier frequencies according to a pre-determined linear sequence, a predetermined non-linear sequence, a random sequence, or concurrently.

30. A method, comprising:
receiving at least one radio frequency signal associated with a plurality of carrier frequencies within a specified frequency band, the plurality of carrier frequencies associated with a pre-determined time period; and
converting the received radio frequency signals to a DC signal.

31. The method of claim 30, wherein the DC signal provides power to at least one of a receiver or a device.

32. The method of claim 30, wherein the received at least one radio signal has a total time-averaged power level above a pre-determined power level.

33. The method of claim 30, wherein the specified frequency band is a first specified frequency band and the pre-determined time period is a first pre-determined time period, the method further comprising receiving at least one radio frequency signal associated with a plurality of carrier frequencies within a second specified frequency band, the plurality of carrier frequencies associated with the second specified frequency band being associated with a second pre-determined time period.

34. The method of claim 30, further comprising transmitting the at least one radio frequency signal.

35. The method of claim 30, further comprising transmitting the at least one radio frequency signal associated with the plurality of carrier frequencies according to a pre-determined linear sequence, a pre-determined non-linear sequence, a random sequence, or concurrently.
